(19) United States
(12) Patent Application Publication
(10) Pub. No.: US 2019/0272608 A1
(43) Pub. Date: Sep. 5, 2019

(54) CLASS SCHEDULE OPTIMIZATION BASED ON PROJECTED STUDENT GROWTH AND ACHIEVEMENT

(71) Applicant: Glimpse K12, Inc., Bay Minette, AL (US)

(72) Inventor: Adam Pearson, Huntsville, AL (US)

(21) Appl. No.: 16/287,865

(22) Filed: Feb. 27, 2019

Related U.S. Application Data
(60) Provisional application No. 62/638,123, filed on Mar. 3, 2018.

(51) Int. Cl. G06Q 50/20; G06Q 10/06; G09B 5/12

(52) U.S. Cl. CPC G06Q 50/205; G09B 5/12; G06Q 10/06398

(57) ABSTRACT

A method and system may be provided to predict student growth and achievement based on growth metrics of one or more teachers. Multiple growth metrics may be provided for a single teacher to allow for multiple growth rates for different types of students at different levels. Predicted growth and achievement may be used as a basis for optimizing a school class schedule or for helping one or more students choose a teacher or school.

### CROSS-REFERENCE TO RELATED APPLICATIONS

This application claims the benefit of U.S. Provisional Patent Application No. 62/638,123, filed Mar. 3, 2018, which is or are all hereby incorporated by reference in their entirety.

### FIELD OF THE INVENTION

The present invention relates to software and hardware for optimizing class schedules or selecting teachers or schools based on predicted student growth or achievement.

### BACKGROUND

School class scheduling traditionally follows an antiquated process. The process involves considering how many classes there are for a particular course, the number of students that need to take the course, and balancing classrooms based on demographic traits such as gender and race. Class scheduling has traditionally been done based on these factors without considering impact of the schedule on student performance.

Moreover, there has not been an effective way to predict growth and achievement of a student based on selection of a teacher or a school or a way to recommend a teacher or school based on the predicted growth and achievement.

It would be desirable to develop and use computer software that would generate school class schedules that would consider the impact of schedules on student performance. With such a tool, students could be placed with teachers that would be most effective for that student. The performance of the student body, or a subset of the student body, could be increased using these techniques. In addition, it would also be desirable to predict growth and achievement of students based on selection of a teacher or school and be able to recommend a teacher or a school on that basis.

### SUMMARY OF THE INVENTION

One embodiment relates to computing a class schedule to increase student growth or achievement.

One embodiment relates to a method for optimizing a class schedule. The method may include computing one or more growth metrics for one or more teachers, each growth metric associated with a measurement type and an achievement level in the measurement type; providing a base class schedule including an assignment of one or more students to classes of one or more teachers; predicting the growth of one or more students by applying one or more growth metrics of a teacher assigned to teach the students in the base class schedule, the growth metrics corresponding to the measurement type and the achievement level of each of the students; receiving optimization criteria from a user, the optimization criteria identifying one or more measurement types for optimization; and generating a new class schedule to increase the predicted growth of one or more students in one or more of the measurement types for optimization, the new class schedule including one or more assignments of teachers to classes, the predicted growth and achievement level of the students in the new class schedule determined by applying the growth metric of the teachers to one or more students in the classes the teachers are assigned to in the new class schedule.

One embodiment relates to predicting the growth of a student when assigned to various teachers who may be at different schools, in order to aid in a school choice selection.

One embodiment relates to a method for predicting growth of a student based on choice of a school. The method may include computing one or more growth metrics for one or more teachers, each growth metric associated with a measurement type and an achievement level in the measurement type, wherein at least some of the teachers are in different schools; predicting the growth of a student by applying the one or more growth metrics of the one or more teachers, the growth metrics corresponding to the measurement type and the achievement level of the student; displaying the predicted growth of the student for each of a plurality of different teachers; and recommending a teacher and a school based on the predicted growth of the student.

### BRIEF DESCRIPTION OF THE DRAWINGS

FIG. 1 illustrates an exemplary method that may be performed in some embodiments.

FIG. 2 illustrates an exemplary subset of growth metrics of a teacher.

FIG. 3 illustrates an exemplary method that may be performed in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Embodiments of the invention may comprise one or more computers. Embodiments of the invention may comprise software and/or hardware. Some embodiments of the invention may be software only and may reside on hardware. A computer may be special-purpose or general purpose. A computer or computer system includes without limitation electronic devices performing computations on a processor or CPU, personal computers, desktop computers, laptop computers, mobile devices, cellular phones, smart phones, PDAs, pagers, multi-processor-based devices, microprocessor-based devices, programmable consumer electronics, cloud computers, tablets, minicomputers, mainframe computers, server computers, microcontroller-based devices, DSP-based devices, embedded computers, wearable computers, electronic glasses, computerized watches, and the like. A computer or computer system further includes distributed systems, which are systems of multiple computers (of any of the aforementioned kinds) that interact with each other, possibly over a network. Distributed systems may include clusters, grids, shared memory systems, message passing systems, and so forth. Thus, embodiments of the invention may be practiced in distributed environments involving local and remote computer systems. In a distributed system, aspects of the invention may reside on multiple computer systems.

Embodiments of the invention may comprise computer-readable media having computer-executable instructions or data stored thereon. A computer-readable media is physical media that can be accessed by a computer. It may be non-transitory. Examples of computer-readable media include, but are not limited to, RAM, ROM, hard disks, flash memory, DVDs, CDs, magnetic tape, and floppy disks.

Computer-executable instructions comprise, for example, instructions which cause a computer to perform a function or group of functions. Some instructions may include data. Computer executable instructions may be binaries, object code, intermediate format instructions such as assembly language, source code, byte code, scripts, and the like. Instructions may be stored in memory, where they may be accessed by a processor. A computer program is software that comprises multiple computer executable instructions.

A database is a collection of data and/or computer hardware used to store a collection of data. It includes databases, networks of databases, and other kinds of file storage, such as file systems. No particular kind of database must be used. The term database encompasses many kinds of databases such as hierarchical databases, relational databases, post-relational databases, object databases, graph databases, flat files, spreadsheets, tables, trees, and any other kind of database, collection of data, or storage for a collection of data.

A network comprises one or more data links that enable the transport of electronic data. Networks can connect computer systems. The term network includes local area network (LAN), wide area network (WAN), telephone networks, wireless networks, intranets, the Internet, and combinations of networks.

In this patent, the term “transmit” includes indirect as well as direct transmission. A computer X may transmit a message to computer Y through a network pathway including computer Z. Similarly, the term “send” includes indirect as well as direct sending. A computer X may send a message to computer Y through a network pathway including computer Z. Furthermore, the term “receive” includes receiving indirectly (e.g., through another party) as well as directly. A computer X may receive a message from computer Y through a network pathway including computer Z.

Similarly, the terms “connected to” and “coupled to” include indirect connection and indirect coupling in addition to direct connection and direct coupling. These terms include connection or coupling through a network pathway where the network pathway includes multiple elements.

To perform an action “based on” certain data or to make a decision “based on” certain data does not preclude that the action or decision may also be based on additional data as well. For example, a computer performs an action or makes a decision “based on” X, when the computer takes into account X in its action or decision, but the action or decision can also be based on Y.

In this patent, “computer program” means one or more computer programs. A person having ordinary skill in the art would recognize that single programs could be rewritten as multiple computer programs. Also, in this patent, “computer programs” should be interpreted to also include a single computer program. A person having ordinary skill in the art would recognize that multiple computer programs could be rewritten as a single computer program.

The term computer includes one or more computers. The term computer system includes one or more computer systems. The term computer server includes one or more computer servers. The term computer-readable medium includes one or more computer-readable media. The term database includes one or more databases.

One or more embodiments relate to a computer program, running on a computer system, for optimizing student class schedules based predicted growth or achievement of students. Growth is a relative metric of how much a student has improved, whereas achievement is absolute. Teacher growth metrics may be computed based on historical data to determine the amount that a teacher is predicted to cause the student to grow over the course of a time period, such as a year or semester. For increased granularity, it may be desirable that the teacher growth metrics be tailored to specific students, based on their attributes, rather than simply being a single growth metric that would apply to all students. Thus, in some embodiments, the growth metrics are associated with certain attributes, such as a level achieved in a given measurement. The growth metric would then apply to students who achieved that specific level in the given metric, for example at the end of the prior year and before the student is incoming into the near year or semester.

Based on the teacher growth metrics, the growth and achievement of one or more students may be predicted. A user may wish to generate a new schedule that optimizes for student growth or achievement in certain measurements. The user may enter optimization criteria, comprising one or more measurements to optimize. The computer system may then generate a new class schedule that optimizes for the optimization criteria. This may be performed, in some embodiments, by matching students to a teacher or teachers who have a better growth metric, versus the baseline schedule, for that particular student (e.g., based on the level of the student in a given measurement in the optimization criteria) to cause the student to grow more in one or more of the measurements selected by the user in the optimization criteria. The computer system may reallocate students to teachers to increase their growth and achievement over the baseline schedule. The computer system may also receive target criteria from the user identifying targets for growth or achievement. The computer system may display to the user whether the targets for growth or achievement were met. If the targets were not met, the computer system may present to the user one or more options of tools, resources, or strategies to apply. The tools, resources, or strategies may also have growth metrics associated with levels in a measurement or demographic information, where the growth metrics predict the growth of students exposed to the tools, resources, or strategies, based on the students' levels or demographic information. The new amount of growth with the tools, resources, or strategies may be computed and compared to the base schedule and targets. A final optimized schedule may be created that improves on the base schedule. The final optimized schedule may meet the target criteria specified by the user.

Thus, some embodiments include optimizing or changing student to teacher assignments, such as in a class schedule, by using predicted scores based on historical teacher and student data.

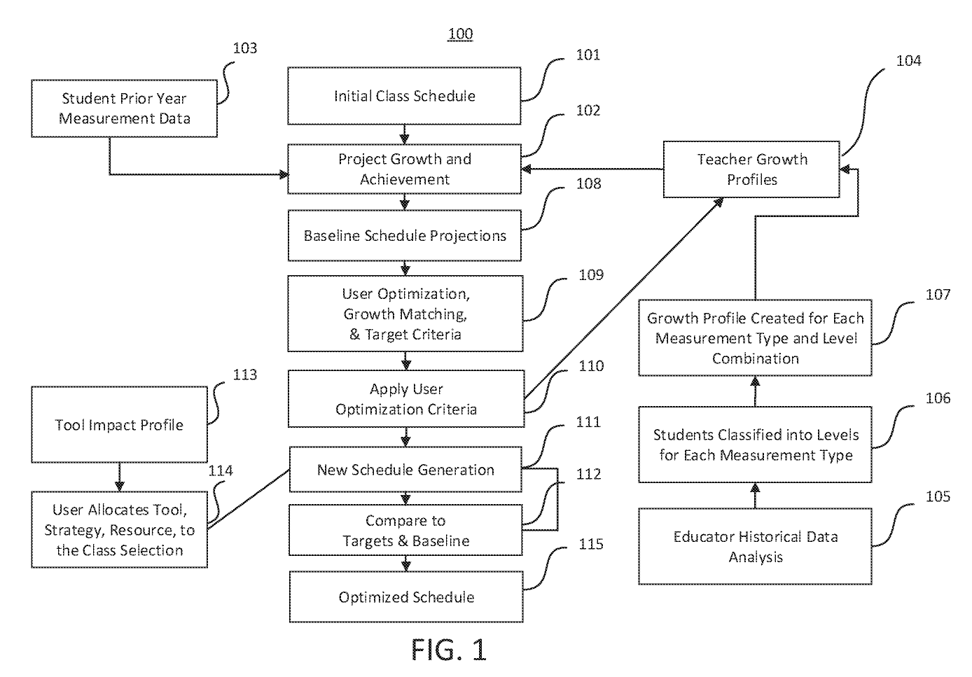

FIG. 1 illustrates an exemplary method 100 that may be performed, by a computer system, in one embodiment. In step 101, an initial class schedule is created or presented to the computer system. The class schedule may include one or more classes taught by one or more teachers. Students in the student body may be assigned to one or more of the classes. Students may be assigned to one class or may be assigned to multiple classes (e.g. science, math, literature, etc.). In some embodiments, the method 100 may be performed on a subset or group of students, rather than an entire class section or student body, to optimize the class schedule for those students.

In step 102, the computer system may project the growth and achievement of the students that would occur based on the class schedule presented in step 101. In this patent, the term predict may also be used in place of the term project. The computer system may store or have access to student prior year measurement data 103. The prior year measurement data 103 may also be referred to as historical student data. The student prior year measurement data may include a level, or score, of each student in the student body on one or more measurements. Measurement examples include high stakes test data, formative assessment data, incremental assessments, interests, goals, attendance rates, discipline rates, and so on. A level is a score or metric, or composite of scores or metrics, in the particular measurement. For example, a score of 415 out of 500 may be a level on a formative assessment test. Similarly an attendance rate of 98% may be a level for a measurement of attendance rates. Ranges may also be used as levels such as scores of 410 to 420 on a formative assessment or attendance rates of 95% to 100%.

In step 104, teacher growth profiles may be provided or computed. Teacher growth profiles may also be referred to as teacher growth metrics. Teacher growth metrics may be provided for one or more, or every, combination of level and measurement. Thus, for a given teacher, a growth metric may be provided for a score of 415 out of 500 on a formative assessment test, and another growth metric may be provided for a score of 416 out of 500 on a formative assessment test. Levels need not correspond to a specific score but can be developed as a composite of multiple scores, such as a range. For example, one level may be scores of 410 to 420 on a formative assessment, and a teacher growth metric may correspond to the range of 410 to 420 on the formative assessment. The teacher growth metric may provide a value that may be used to project or predict student growth or achievement in the measurement over a given period of time, such as a year or semester, for a student at the corresponding level in the measurement when the student is assigned to the class of this teacher. For example, a teacher growth metric for the range 410 to 420 on a formative assessment may provide a value that projects or predicts the growth or achievement of a student with a score in the range of 410 to 420 in that formative assessment. In some embodiments, the teacher growth metric may be a percentage such as 7%, indicating a predicted growth of 7% in the measurement for students at a corresponding level in the measurement. The teacher growth metric may be stored in various ways, such as a multiplicative factor (e.g. 1.07) that may be multiplied with a student's level of achievement to predict the level of achievement of the student after the given period of time in the teacher's class. Growth is a measure of the change in student achievement over time, whereas an achievement level is an absolute (as opposed to relative) measure of performance.

The growth metrics for teachers may be computed based on past historical data about how past students in their classes performed. Specifically, the growth metrics may be computed based on a per level and per measurement basis to determine the teacher's performance in growing student achievement for students at a given level in a measurement. In step 105, educator historical data analysis may be performed to collect information about past performance of one or more teachers in prior classes that they taught. In step 106, students in the teachers' classes may be classified into levels for each measurement type being considered. In step 107, a growth metric for each teacher may be computed for each measurement type and level combination.

With the student prior year measurement data 103 and the teacher growth profiles 104, growth and achievement of one or more students may be projected or predicted 102 to obtain baseline schedule projections 108. Student prior year measurement data 103 may be the ending point for each student from the prior period (e.g. year or semester). The computer system may apply the teacher growth profiles 104 to students based on the level of each student in each measurement to project growth in every measurement, or a subset of measurements. The process may project individual growth rates for each student and one for the class section or student body as a whole. The result of the calculation may be a predicted growth and level of achievement for each measurement, for each student, and the class section or student body as a whole. The projection process 102 may include additional teacher measurement attributes associated with teachers in their teacher profiles. These additional attributes may include measures of classroom management, student engagement, project-based learning, teaching style, and so on. The additional attributes may be used in combination with the teacher growth metrics to predict student growth in each measurement.

In step 108, a projected growth rate for the class section, or student body, and achievement level are determined.

In step 109, optimization, growth matching, and target criteria may be received as input from a user. Optimization criteria may indicate one or more measurement types as the primary criteria for optimization. Selections of optimizations may be hierarchical, with optimizations being made based on a first measurement, then a second measurement, then a third measurement, and so on. Growth matching criteria received from the user may indicate whether the computer system will allow a 1:1 student to teacher growth metric match or allow a 1:X match. If 1:1 match is selected, the computer system only selects a teacher growth metric attribute if it directly matches the incoming profile level (level in the given measurement) of the student. If 1:X match is selected, then selection broadens to search X number of the nearest levels for a teacher growth metric. Thus, in the 1:X option, a teacher growth metric may be applied to predict student growth if the growth metric is near, but not identical, to the level of the student in the measurement. The number X may be selected or configured by the user or provided by the computer system. In one embodiment, the 1:X match is performed by creating larger bins from the individual levels. Each bin comprises a range of X levels, for example a bin may be levels 411 to 415 if X equals 5. The predicted growth of the bin may be the average of the predicted growth of each level. Student growth may be predicted by identifying the corresponding bin based on the achievement level of the student and applying the average growth metric computed on the levels in the bin to predict the growth and achievement level of the student.

Target criteria may also be received from the user. Target criteria may be set for each measurement type, grade, school course, or combination. Target criteria are the thresholds for growth and achievement that the user wants to meet. The computer system may use the target criteria to determine how many students are above or below the target criteria and to what degree. The computer system may display to the user an indication of the number of students above or below the target criteria and to what degree.

In step 110, the computer system may apply the optimization criteria input by the user. The computer system may determine for each student whether the student is currently scheduled with the best fit teacher. The best fit teacher may be determined to best match student weaknesses with teachers' strengths. In some cases, the best fit teacher may be the teacher for which predicted growth or achievement is the highest, or at least higher than in the base schedule, for the student in the measurement types selected in the user optimization criteria. If a student is not scheduled with the best fit teacher in the base schedule, the computer system may select the appropriate growth metrics for alternate available teachers for each student based on the student's profile, including base levels of achievement from prior year measurement data 103. These growth profiles are applied to each students' corresponding base levels of achievement to project achievement for each student and group of students under the alternative schedules. The computer system may identify a measurement type selected in the user optimization criteria, identify each students' level in the measurement type, find the teacher with the highest growth metric for that achievement level in the measurement type (or at least higher than in the base schedule), and assign students to the appropriate teacher based on the teacher having the highest growth metric for that achievement level in the measurement type (or at least higher than in the base schedule) among available teachers.

In step 111, the computer system may generate a new schedule with new projections for growth and achievement based on the assignment of students to teachers. The new schedule may assign students to better fit teachers than in the base schedule, based on predicted growth being higher in the desired measurement types selected in the user optimization criteria.

In step 112, the projected student growth and achievement in the new schedule may be compared with the base schedule and with the target criteria received from the user. If the target criteria is not met, options may be displayed or presented to the user to allocate a tool, resource, or strategy to a class section to improve projected achievement levels.

In step 113, the computer system may provide a growth profile, also known as growth metric, for each tool, resource, or strategy that is available. The growth metric may be computed based on historical student profiles that were exposed to the tool, resource, or strategy. In an embodiment, the growth metric is a percentage of expected growth or a multiplier, which may be used to calculate predicted growth of students. Each tool, resource, or strategy may have multiple growth metrics, one for each set of students, where the sets of students may be identified by their level in a measurement, demographics, and so on. For example, a tool, resource, or strategy may have a first growth metric applicable to a first set of students having a first level in a measurement and a second growth metric applicable a second set of students having a second level in the measurement. The growth metrics may be computed by analyzing historical data for students at various levels in one or more measurements, and with varying demographics, and determining the appropriate growth metric for students in the appropriate category.

In step 114, input may be received from the user to allocate a tool, strategy, or resource to the students. The allocation of the tool, strategy, or resource may be applied in the new schedule generation 111. The growth metrics of the tool, strategy, or resource may be applied to predict the growth and achievement of the students in the new class schedule. This may be performed by determining the appropriate growth metric to apply to each student based on the level in a measurement and/or demographic information of the student. The growth metric of the tool, strategy, or resource may then be applied to the student to predict the growth or achievement of the student. The results of the new schedule may then be compared with the baseline schedule and target criteria, this time inclusive of the growth provided by the tool, strategy, or resource.

In step 115, the final optimized schedule may be created. This may occur when the new schedule meets the target criteria of the user.

The method 100, and variations thereof, may be performed on entire student bodies, class sections, or subsets or groups of one or more students.

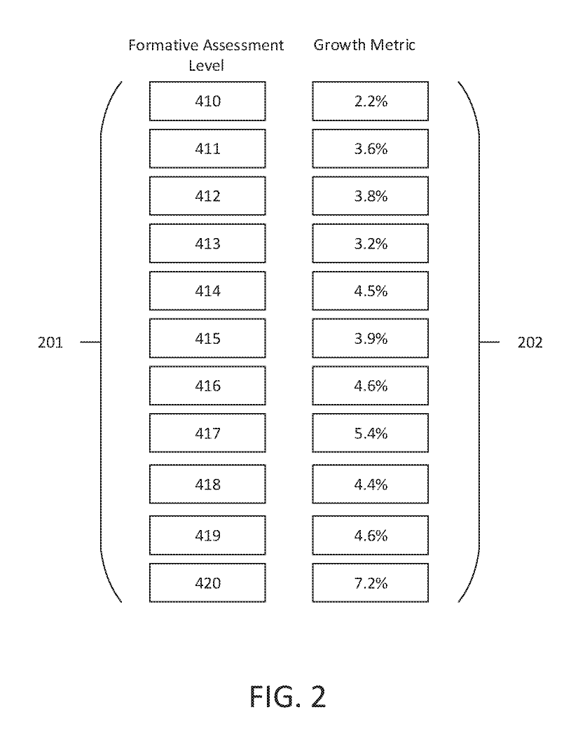

FIG. 2 illustrates an exemplary subset of growth metrics for a teacher. In the example, the growth metrics correspond to a measurement, and the measurement is a formative assessment with various levels. A formative assessment may include a number of levels, such as levels 0 to 500, where the students are assigned to a level based on their performance on the formative assessment. Levels 201 are shown in this example ranging from 410 to 420, but many more levels may be included and not shown. Growth metrics 202 include one growth metric for each level in the measurement. The growth metric may indicate the predicted growth of a student that is in the class of this teacher, where the student's base level is at the corresponding level 201 of the formative assessment. For example, for this teacher, a student ending the prior period with level 414 may be expected to grow 4.5% under this teacher on this particular measurement. Growth metrics may be provided for teachers in many different measurements. Some examples of measurements include high stakes test data, formative assessment data, incremental assessments, interests, goals, attendance rates, discipline rates. Some examples of levels include test scores in high stakes tests, test scores in formative assessments, test scores in incremental assessments, interests in a set of potential interests, goals in a set of potential goals, rates of attendance (such as percentage attendance or number of days), and rates of discipline.

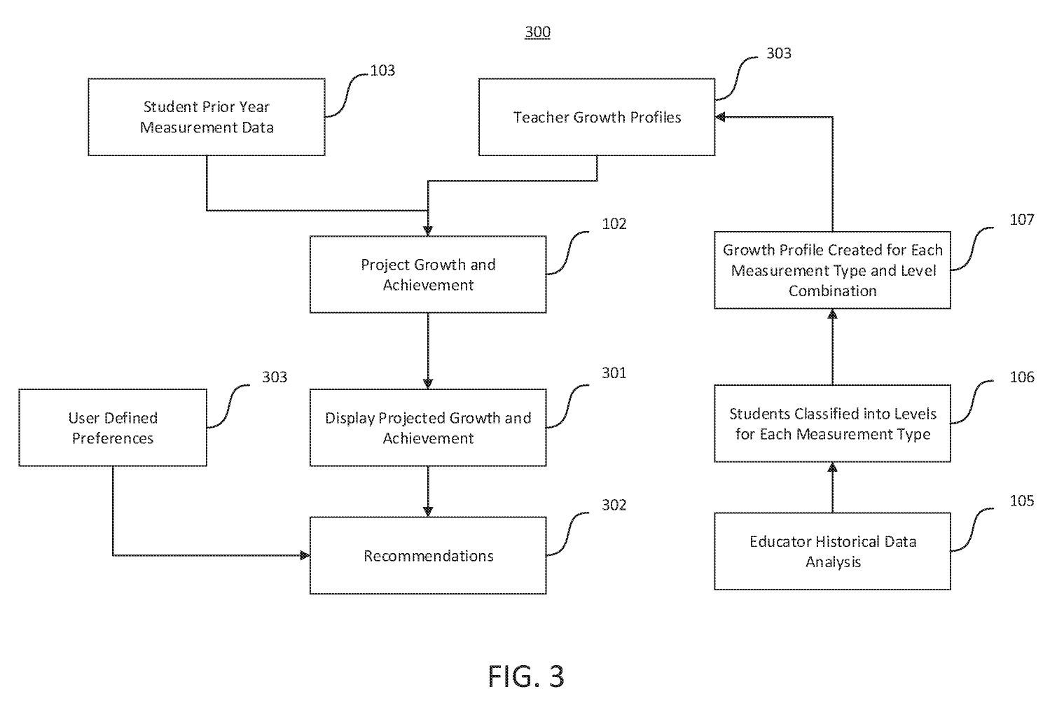

FIG. 3 illustrates an exemplary method 300, performed by a computer system, for helping students and parents choose a teacher. In some embodiments, method 300 may be used to select a teacher from a set of multiple potential schools that the student could attend. School choice and school selection provides students and teachers with greater options for receiving a high quality education. Traditionally, the process of assigning students to schools has been essentially a lottery with various demographic weighting applied. The disadvantages of this method include the inability to match students to the school or teacher where they will be most successful in terms of growth and achievement. The school chosen through the lottery method may not be the best for each individual student.

Method 300 uses teacher growth profiles, or growth metrics, and student information to match a student or students to the best teacher for that student. It may be used across choices of teachers from multiple different schools. In this way, method 300 may help match students to the best school when multiple options are available. Method 300 may be applied to a single student or multiple students.

In step 103, student prior year measurement data is provided, which has been previously described. Moreover, teacher growth profiles, also known as growth metrics, may be provided in step 303. This step is the same as step 104 except that the teacher growth profiles may come from multiple schools rather than just a single school. In this way, predictions of student growth can be made for teachers from different schools. The teacher growth profiles may be calculated from historical data as discussed previously using educator historical data analysis 105, classifying students into levels for each measurement type 106, and creating a growth profile for each measurement type and level combination 107.

In step 301, the computer system may display the projected growth and achievement of student with various teachers. The display may allow the comparison of the expected success of the student with the different possible teachers. The computer system may select or highlight the best match teachers. The best matching teachers may be those that are predicted to create the most growth for the student in one or more measurements of interest. Measurements of interest may be measurements where the student is weak (lower level) or strong (higher level). In some cases, it may be desirable to match teacher strengths to student weaknesses, in which case a student may be matched with a teacher that has the highest growth metric for a measurement where the student is weaker or at a lower level. In step 302, the computer system may make recommendations of the best teacher or teachers for the student or students. The computer system may take into account optimization criteria based on the student's level, such as areas of strength or weakness. Moreover, the computer system may take into account in its recommendations user defined preferences 303. User defined preferences 303 may be received from a parent or guardian. Based on the recommendation of a teacher, the computer system may also recommend a school, where the recommended school is the school where the recommended teacher teaches.

Thus, some embodiments include recommending a teacher or school based on predictive outcomes based on historical teacher and student data.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed:

1. A method for optimizing a class schedule, the method performed by a computer system, the method comprising:
computing one or more growth metrics for one or more teachers, each growth metric associated with a measurement type and an achievement level in the measurement type;
providing a base class schedule including an assignment of one or more students to classes of one or more teachers;
predicting the growth of one or more students by applying one or more growth metrics of a teacher assigned to teach the students in the base class schedule, the applied growth metrics corresponding to the measurement type and the achievement level of each of the students;
receiving optimization criteria from a user, the optimization criteria identifying one or more measurement types for optimization;
generating a new class schedule to increase the predicted growth of one or more students in one or more of the measurement types for optimization, the new class schedule including one or more assignments of teachers to classes, the predicted growth of the students in the new class schedule determined by applying the growth metric of the teachers to one or more students in the classes the teachers are assigned to in the new class schedule.

2. The method of claim 1, wherein the measurement type associated with the growth metrics of the one or more teachers comprises at least one of high stakes test data, formative assessment data, incremental assessment data, attendance rates, or discipline rates.

3. The method of claim 1, further comprising:
computing the one or more growth metrics for the one or more teachers by using past data on the growth of students in the classes of the one or more teachers.

4. The method of claim 1, further comprising:
providing base achievement levels of one or more students in a measurement type.

5. The method of claim 1, wherein the growth metrics for the one or more teachers are growth multipliers that predict growth of a student at a given level in a measurement type.

6. The method of claim 1, wherein the predicted growth of the students in the new class schedule is determined by multiplying the growth metric of the teachers to one or more students in the classes the teachers are assigned to in the new class schedule

7. The method of claim 1, further comprising:
receiving growth matching criteria from the user;
matching one or more students to teachers based on the growth matching criteria.

8. The method of claim 1, further comprising:
receiving target criteria from the user, the target criteria comprising a threshold of growth in a measurement type;
displaying to the user an indication of the number of students above the threshold of growth or below the threshold of growth in the new class schedule.

9. The method of claim 1, further comprising:
computing one or more growth metrics of a tool, resource, or strategy that may be applied to students;
predicting the growth of one or more students from application of the tool, resource, or strategy based on the growth metrics of the tool, resource, or strategy.

10. The method of claim 1, further comprising:
computing one or more growth metrics of a tool, resource, or strategy that may be applied to students, each of the growth metrics associated with an achievement level and a demographic;
predicting the growth of one or more students from application of the tool, resource, or strategy based on the growth metrics of the tool, resource, or strategy.

11. A method for predicting growth of a student based on choice of a teacher, the method performed by a computer system, the method comprising:
computing one or more growth metrics for one or more teachers, each growth metric associated with a measurement type and an achievement level in the measurement type;
predicting the growth of a student by applying the one or more growth metrics of the one or more teachers, the applied growth metrics corresponding to the measurement type and the achievement level of the student;
displaying the predicted growth of the student for each of a plurality of different teachers;
recommending a teacher and a school based on the predicted growth of the student.

12. The method of claim 11, wherein the measurement type associated with the growth metrics of the one or more teachers comprises at least one of high stakes test data, formative assessment data, incremental assessment data, attendance rates, or discipline rates.

13. The method of claim 11, wherein at least some of the teachers are in different schools.

14. The method of claim 11, further comprising:
computing the one or more growth metrics for the one or more teachers by using past data on the growth of students in the classes of the one or more teachers.

15. The method of claim 11, further comprising:
providing a base achievement level of the student in the measurement type.

16. The method of claim 11, wherein the growth metrics for the one or more teachers are growth multipliers that predict growth of a student at a given level in a measurement type.

17. The method of claim 11, wherein the predicted growth of the student is determined by multiplying the growth metric of the teachers.

18. The method of claim 11, further comprising:
computing one or more growth metrics of a tool, resource, or strategy that may be applied to the student;
predicting the growth of the student from application of the tool, resource, or strategy based on the one or more growth metrics of the tool, resource, or strategy.

19. The method of claim 11, further comprising:
computing one or more growth metrics of a tool, resource, or strategy that may be applied to the student, each of the growth metrics associated with an achievement level and a demographic;
predicting the growth of the student from application of the tool, resource, or strategy based on the growth metrics of the tool, resource, or strategy.

20. A method for optimizing a class schedule, the method performed by a computer system, the method comprising:
computing one or more growth metrics for one or more teachers, each growth metric associated with a measurement type and an achievement level in the measurement type;
receiving a base class schedule including an assignment of one or more students to classes of one or more teachers;
predicting the growth of one or more students by applying one or more growth metrics of a teacher assigned to teach the students in the base class schedule, the applied growth metrics corresponding to the measurement type and the achievement level of each of the students;
receiving optimization criteria from a user, the optimization criteria identifying one or more measurement types for optimization;
generating a new class schedule to increase the predicted growth of one or more students in one or more of the measurement types for optimization, the [new class schedule including one or more assignments of teachers to classes, the predicted growth of the students in the new class schedule determined by applying the growth metric of the teachers to one or more students in the classes the teachers are assigned to in the new class schedule.
